(19) United States
(12) Patent Application Publication
(10) Pub. No.: US 2014/0223112 A1
(43) Pub. Date: Aug. 7, 2014

(54) SYSTEM AND METHOD FOR MANAGING DATA ELEMENTS

(71) Applicant: CAA SOUTH CENTRAL ONTARIO, Thornhill (CA)

(72) Inventors: Kirk Serjeanston, Markham (CA); Sean Macdonald, Uxbridge (CA); Kevin Ng, Markham (CA); Emilio Rojas-Silva, Stouffville (CA); Jonathan Maynard, Brampton (CA); Adam Stevenson, Hamilton (CA)

(73) Assignee: CAA SOUTH CENTRAL ONTARIO, Thornhill (CA)

(21) Appl. No.: 13/759,651

(22) Filed: Feb. 5, 2013

(51) Int. Cl. G06F 12/00

(52) U.S. Cl. CPC G06F 12/00
USPC 711/147

(57) ABSTRACT

Systems and methods for managing data elements on a mobile device that involve identifying a central application with an available set of data elements, for each of a plurality of secondary applications, determining a shared set of data elements where each data element of the shared set of data elements is mapped to a data element of the available set of data elements. The systems and methods may further involve receiving the available set of data elements from the external data storage device for storage in a virtual memory of the mobile device upon detecting that a central application has initialized on the mobile device and populating a secondary application with the shared set of data elements from the virtual memory upon detecting that the secondary application has initialized on the mobile device.

### FIELD

The embodiments described herein relate to systems and methods for managing data elements, and in particular, to systems and methods for managing data elements used by different computing applications on a mobile device.

### INTRODUCTION

A computing application may have variable data elements which may be received as input via manual entry in a keypad and the like by a user. The same data elements may be required by multiple applications which may create redundant data entry and input errors as a user may be required to re-enter the same data elements into different applications. A database may be used to store data elements but typically databases require a lot of memory. A comprehensive application may include the functionality provided by multiple applications but typically a comprehensive application may use a lot of processing power and only some of the functionality may be relevant to a particular user. A mobile device may have limited memory and processing resources. There exists the need for a system and method that manages data elements for use by different computing applications on a mobile device.

### SUMMARY

In a first aspect, embodiments described herein provide a method for managing data elements on a mobile device, wherein the mobile device comprises a processor and a memory coupled to the processor and configured to store instructions executable by the processor to perform the method comprising: identifying a central application residing in the memory of the mobile device, wherein the central application has an available set of data elements, wherein the central application is in communication with an external data storage device storing the available set of data elements; for each of a plurality of secondary applications residing in memory of the mobile device, determining a shared set of data elements using the processor, wherein each data element of the shared set of data elements is mapped to a data element of the available set of data elements; upon determining that a central application has initialized on the mobile device, receiving the available set of data elements from the external data storage device for storage in a virtual memory of the mobile device; and upon determining that a secondary application of the plurality of secondary applications has initialized on the mobile device, populating the secondary application with data elements of the available set of data elements stored in the virtual memory that are mapped to data elements of the shared set of data elements of the secondary application.

In accordance with some embodiments, the plurality of secondary applications may be located within a menu bar of a user interface for the mobile device.

In accordance with some embodiments, a data element may have a data field and a corresponding data value, wherein the data field indicates the location within the secondary application to be populated with the data value.

In accordance with some embodiments, a secondary application of the plurality of secondary applications may have a base set of data elements, wherein the shared set of data elements for the secondary application is a subset of the base set of data elements, wherein the base set of data elements comprises at least one data element that is not part of the shared set of data elements, and wherein the method further comprises: receiving a data value for the at least one data element that is not part of the shared set of data elements.

In accordance with some embodiments, the method may further involve upon determining that the at least one data element that is not part of the shared set of data elements is required by the central application, providing the data value for the at least one data element that is not part of the shared set of data elements to the central application.

In accordance with some embodiments, the method may further involve updating the available set of data elements for the central application to comprise the at least one data element that is not part of the shared set of data elements.

In accordance with some embodiments, the method may further involve, for each of a plurality of secondary applications residing in memory of the mobile device, re-determining a shared set of data elements, wherein each data element of the shared set of data elements is mapped to a data element of the updated available set of data elements.

In accordance with some embodiments, the method may further involve transmitting the data value for storage on the external storage device.

In accordance with some embodiments, the method may further involve storing the data value in the virtual memory of the mobile device.

In accordance with some embodiments, the central application is in communication with an external data storage device storing the available set of data elements to receive real time updates to the available set of data elements stored in the virtual memory of the mobile device.

In another aspect, embodiments described herein may provide a system for managing data elements on a mobile device, wherein the mobile device comprises a processor and a memory coupled to the processor and configured to store instructions executable by the processor to: identify a central application residing in the memory of the mobile device, wherein the central application has an available set of data elements, wherein the central application is in communication with an external data storage device storing the available set of data elements; for each of a plurality of secondary applications residing in memory of the mobile device, determine a shared set of data elements, wherein each data element of the shared set of data elements is mapped to a data element of the available set of data elements; upon determining that a central application has initialized on the mobile device, receive the available set of data elements from the external data storage device for storage in a virtual memory of the mobile device; and upon determining that a secondary application of the plurality of secondary applications has initialized on the mobile device, populate the secondary application with data elements of the available set of data elements stored in the virtual memory that are mapped to data elements of the shared set of data elements of the secondary application.

In accordance with some embodiments, the plurality of secondary applications may be located within a menu bar of a user interface for the mobile device.

In accordance with some embodiments, each data element comprises a data field and a corresponding data value, wherein the data field indicates the location within the secondary application to be populated with the data value.

In accordance with some embodiments, a secondary application of the plurality of secondary applications may have a base set of data elements, wherein the shared set of data elements for the secondary application is a subset of the base set of data elements, wherein the base set of data elements comprises at least one data element that is not part of the shared set of data elements, and wherein the method further comprises: receiving a data value for the at least one data element that is not part of the shared set of data elements.

In accordance with some embodiments, the processor may be further configured to, upon determining that the at least one data element that is not part of the shared set of data elements is required by the central application, provide the data value for the at least one data element that is not part of the shared set of data elements to the central application.

In accordance with some embodiments, the processor may be further configured to update the available set of data elements for the central application to comprise the at least one data element that is not part of the shared set of data elements.

In accordance with some embodiments, the processor may be further configured to, for each of a plurality of secondary applications residing in memory of the mobile device, re-determining a shared set of data elements, wherein each data element of the shared set of data elements is mapped to a data element of the updated available set of data elements.

In accordance with some embodiments, the processor may be further configured to transmit the data value for storage on the external storage device.

In accordance with some embodiments, the processor may be further configured to store the data value in the virtual memory of the mobile device.

In accordance with some embodiments, the processor may be further configured to, wherein the central application is in communication with an external data storage device storing the available set of data elements to receive real time updates to the available set of data elements stored in the virtual memory of the mobile device.

Other aspects and features will become apparent, to those ordinarily skilled in the art, upon review of the following description of some exemplary embodiments.

### DRAWINGS

Various embodiments will now be described, by way of example only, with reference to the following drawings, in which:

FIG. 1 is a schematic diagram of a system for managing data elements according to some embodiments;

FIG. 2 is a schematic diagram of a user device configured with an enterprise mobility application connector for managing data elements according to some embodiments;

FIG. 3 is another schematic diagram of a user device configured with an enterprise mobility application connector according to some embodiments;

FIG. 4 is a schematic diagram illustrating data flow from secondary applications to an enterprise mobility application connector and a central application system according to some embodiments;

FIG. 5 is a schematic diagram illustrating data flow from a central application system to an enterprise mobility application connector and secondary applications according to some embodiments; and

FIG. 6 is a flow chart diagram of a method for managing data elements according to some embodiments.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

### DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

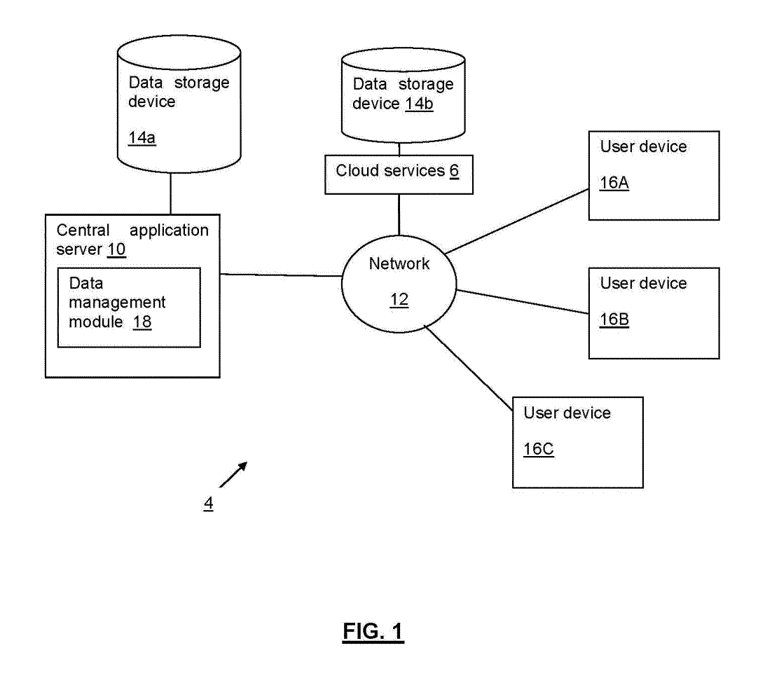

Referring now to FIG. 1 there is shown a schematic diagram of a system 4 particularly configured for managing data elements according to some embodiments. System 4 may include a central application server 10 connected to one or more user devices 16 via a network 12. Central application server 10 may be particularly configured to manage data elements used by applications residing on user device 16.

As an illustrative example, central application server 10 may provide an application centre for various users, such as contractors, and more specifically, tow truck drivers, where the application centre may make available a number of available applications for installation on the user device 16 of the user. The user device 16 may contain a central application that ties into the central application server 10 and the user device 16 may also contain a number of secondary applications for the contractor network. These secondary applications may be developed specifically for the individual contractors or may be available as part of the application centre. Information (e.g. data elements) stored at the central application server 10 for the central application may be distributed to individual separate secondary applications that use the some or all of the same information as the central application. Embodiments described herein may provide an interactive real time variable process to store different data elements for the central application in virtual memory of a user device 16 for distribution to and use in the various secondary applications on the user device 16. Embodiments described herein may allow multiple secondary applications to be integrated together as they may share data elements of the central application to avoid redundant data entry and input errors.

Central application server 10 may be implemented using a server and data storage devices 14a, 14b configured with database(s) or file system(s), or using multiple servers or groups of servers distributed over a wide geographic area and connected via a network 12. Central application server 10 may be connected to a data storage device 14a directly or via to a cloud based data storage device 14b via network 12. Central application server 10 may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. Central application server 10 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Central application server 10 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. Central application server 10 may include one or more input devices, such as a keyboard, mouse, camera, touch screen and a microphone, and may also include one or more output devices such as a display screen and a speaker. Central application server 10 has a network interface in order to communicate with other components, to serve a central application and other applications, and perform other computing applications by connecting to network 12 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one central application server 10 is shown for clarity, there may be multiple central application server 10 or groups of central application server 10 distributed over a wide geographic area and connected via e.g. network 12.

Central application server 10 generally connects with one or more data storage devices 14a, 14b (e.g., memory, and the like), and could include a relational database (such as a SQL database), or other suitable data storage mechanisms. Data storage devices 14a, 14b are operable to store data records for central application server 10, central application, and secondary applications such as data for provision to user devices 16 or data received from user device 16. The cloud based data storage device 14b may be accessible to user device 16 through a cloud services 6 interface. Cloud computing generally is the use of computing hardware and software resources that are delivered as a service over a network 12 to user device 16 or central application server 10. In some embodiments, the central application server 10 may also have one or more backup servers that may duplicate some or all of the data stored on the data storage devices 14a, 14b. The backup servers may be desirable for disaster recovery (e.g., to prevent undesired data loss in the event of an event such as a fire, flooding, or theft). In some embodiments, the backup servers may be directly connected to the central application server 10 but located at a different physical location.

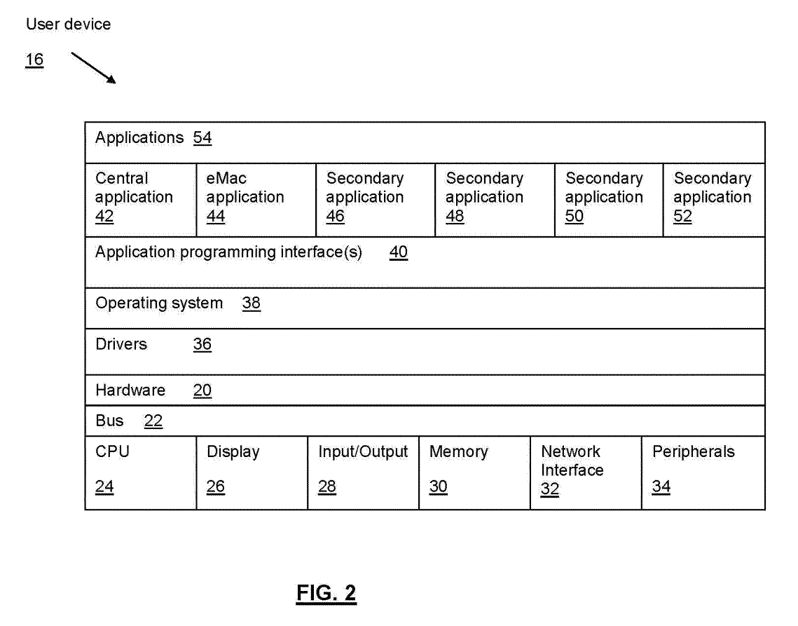

Central application server 10 may be particularly configured with a data management module 18 for receiving requests from a central application 42 or enterprise mobility application connector (eMac) 44 residing on user device 16 for data elements (FIG. 2). In response, data management module 18 provides the data elements to the central application 42 or the eMac application 44 for storage in virtual memory of the user device 16 in order to make the data elements available to the secondary applications 46, 48, 50, 52 (FIG. 2). Data management module 18 stores data elements available to and required by central application 42. Data management module 18 receives new data elements and updates existing data elements and provides the new data elements and updated data elements to central application 42 residing on user device 16 in a push or pull fashion. Further, data management module 18 receives new data elements and updates existing data elements in response to receiving data elements from secondary application 44 via eMac application 44.

User device 16 is operable by a user and may be any portable, networked (wired or wireless) computing device including a processor and memory and suitable for facilitating communication between one or more computing applications of user device 16 (e.g. a computing application installed on or running on the user device 16), the central application server 10, and cloud services 6.

In accordance with some embodiments, user device 16 may be a mobile computing device, such as an enterprise mobile computing device. A mobile computing device may be a two-way communication device with advanced data communication capabilities having the capability to communicate with other computer systems and devices. The mobile device may include the capability for data communications and may also include the capability for voice communications. Depending on the functionality provided by the mobile device, mobile device may be referred to as a portable electronic device, smartphone, a data messaging device, a two-way pager, a cellular telephone with data messaging capabilities, personal digital assistant, a wireless Internet appliance, a portable laptop computer, a tablet computer, a media player, an electronic reading device, a data communication device (with or without telephony capabilities) or a combination of these. The user device 16 may be mounted, installed, or otherwise integrated with a vehicle. Non-limiting examples of a vehicle include: a car, truck, or other automobile; an airplane or other aircraft; and a boat, ship, or other marine vessel. Although only three user devices 16A, 16B, 16C are illustrated in FIG. 1, there may be fewer or more user devices 16 connected to a central application server 10 via network 12. User device 16 may be connected to the central application server 10 via any suitable communications channel. For example, the user device 16 may communicate to the central application server 10 over a Local Area Network (LAN) or intranet, or using an external network. User device 16 may also have additional embedded components such as a global positioning system (GPS), a clock, a calendar, and so on. User device 16 may also be connected to and receive data from other devices that collect data regarding the user, objects associated with the user, and so on. For example, user device 16 may be connected to a navigation system, electronic mapping tool, fleet management tool, back office system, satellite device, diagnostic tool, tracking devices, radio device, receiver/transmitter/modem and other vehicle telematics devices. For example, a vehicle telematics device is a way of monitoring the location, movements, status, components and behaviour of a vehicle. Further details of user device 16 will be described in relation to FIG. 2.

Network 12 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although not shown, central application server 10, user device 16, and other components (not shown) may connect to network 12 via a firewall, which is a device, set of devices or software that inspects network traffic passing through it, and denies or permits passage based on a set of rules and other criteria. Firewall may be adapted to permit, deny, encrypt, decrypt, or proxy all computer traffic between network 12, central application server 10, user device 16, and other components based upon a set of rules and other criteria. For example, firewall may be a network layer firewall, an application layer firewall, a proxy server, or a firewall with network address translation functionality. Network 12 is operable to secure data transmissions using encryption and decryption.

Referring now to FIG. 2 there is shown a schematic diagram of a user device 16 configured with an enterprise mobility application connector (eMac) 44 for managing data elements used by applications residing on the user device 16 according to some embodiments.

User device 16 may be configured with various computing applications 54, such as a central application 42, eMac application 44, and secondary applications 46, 48, 50, 52. A computing application 54 may correspond to software modules comprising computer executable instructions to configure physical hardware to perform various functions and discernable results. A computing application 54 may be a computer software or hardware application designed to help the user to perform specific functions, and may include an application plug-in, a widget, instant messaging application, mobile device application, e-mail application, online telephony application, java application, web page, or web object residing, executing, running or rendered on the user device 16. User device may include a central application 42 in order to access the functionality of central application server 10, by providing and receiving data and carrying out actions and instructions, for example. User device 16 is operable to register and authenticate users (using a login, unique identifier, and password for example) prior to providing access to applications 54 and central application server 10. User devices 16 may be different types of devices and may serve one user or multiple users. Although user device 16 is depicted with various components in FIG. 2 as a non-limiting illustrative example, user device 16 may contain additional or different components.

Embodiments described herein may be specifically configured for enterprise mobile devices (e.g. user device 16). A number of disparate independent secondary applications 46, 48, 50, 52 may be tied together through a single central application 42 on a user device 16, such as a mobile device, by sharing data elements among the applications 40. This may allow users to move more quickly from secondary application 46, 48, 50, 52 to secondary application 46, 48, 50, 52 without redundant data entry. Typically databases may be used to leverage consistent information. Secondary applications 46, 48, 50, 52 may be transaction based applications, and consistent information across secondary applications 46, 48, 50, 52 may be held in a more accessible format for an enterprise mobile device (e.g. user device 16). This process may allow multiple secondary applications 46, 48, 50, 52 on a single user device 16 to share pertinent information across applications 40. Databases on a user device 16 may require a lot of memory 30 to store and virtual memory to run. Keeping key variables or data elements available across secondary applications 46, 48, 50, 52 through virtual memory may be more efficient. Embodiments described herein may allow multiple variables (e.g. data elements) to be used across multiple secondary applications 46, 48, 50, 52. Another problem with database use may be that the secondary applications 46, 48, 50, 52 need to be configured to that specific database. This may cause issues when secondary applications 46, 48, 50, 52 that are developed in isolation by different developers. By using the eMac application 44, embodiments described herein may allow multiple independent secondary applications 46, 48, 50, 52 to share key data elements without requiring the secondary applications 46, 48, 50, 52 to be particularly configured for a specific database.

User device 16 may store in memory 30 a central application 42 with a number of secondary applications 46, 48, 50, 52 for the user. The secondary applications 46, 48, 50, 52 may be chosen by the individual user/operator to suit their specific needs. The user may require a device 16 and secondary applications 46, 48, 50, 52 to perform specific duties. Independent developers or administrative users may develop a range of secondary applications 46, 48, 50, 52 that the contractor or user can use to run their business. The secondary applications secondary applications 46, 48, 50, 52 may require similar information (e.g. data elements) from the central application 42. Each secondary application secondary application 46, 48, 50, 52 could require different information than another secondary application secondary applications 46, 48, 50, 52.

In accordance with some embodiments, user device 16 may continually run the central application 42 and open secondary applications 46, 48, 50, 52 when needed. As an illustrative example, the user may be a tow truck operator contracting with a vehicle services company. The central application 42 may be a dispatch application and may be primarily used by the tow truck operator for their business in order to receive service requests for tows and receive information about the requester, the associated vehicle, the location of the service request, and so on. Secondary applications 46, 48, 50, 52 may provide additional functionality to assist the two truck operator in their business. The additional functionality provided by secondary applications 46, 48, 50, 52 may only be required for specific circumstances and may not be required for all jobs. For example, a secondary application 46, 48, 50, 52 may be used to take pictures of a vehicle when damage is detected by the tow truck operator prior to the tow as evidence that the tow truck operator was not responsible for the damage.

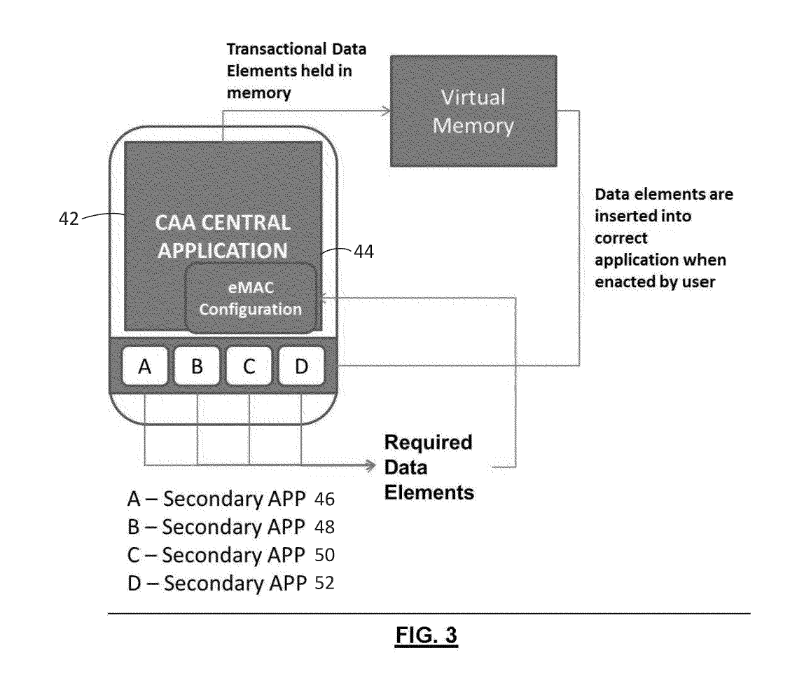

Icons used to initialize the secondary applications 46, 48, 50, 52 may be in a tool bar or menu bar located at the bottom of the screen relative to the central application 42 and eMac application 44 (see FIG. 3 as a non-limiting example). User device 16 may provide a user interface with a toolbar or widget on which on-screen buttons, icons, menus, or other input or output elements may be placed. The tool bar may have icons for secondary applications 46, 48, 50, 52, and the selection of which secondary applications 46, 48, 50, 52 to place in tool bar may be specified by the user or an associated organization. In some embodiments once the link is made to the secondary applications 46, 48, 50, 52 in the tool bar, eMAC application 44 may configure the shared set of data elements for each secondary application 46, 48, 50, 52. Referring back to the illustrative example, the central application 42 may be a dispatch application with data elements about the service requester and the vehicle to be towed, and so on. The secondary application 46, 48, 50, 52 may be a damage photo application with a data form for receiving input data regarding the photo of the vehicle damage, where the data form may include some of the same data elements as the central application 42. eMAC application 44 may share those same data elements from the central application 42 with the secondary application 46, 48, 50, 52 and automatically populate the data form with the shared data elements to avoid redundant data entry and decrease memory usage for overlapping data elements.

eMAC application 44 may be particularly configured to identify the central application 42 among applications 40 residing on the user device 16 and its corresponding available set of data elements. The available set of data elements may be stored at central application server 10 or data storage device 14a, 14b. eMAC application 44 may be particularly configured to identify a set of secondary applications 46, 48, 50, 52, among applications 40 residing on the user device 16. For example, this may be the set of secondary applications 46, 48, 50, 52 on the tool bar or menu bar, or otherwise. eMAC application 44 may be particularly configured to determine a shared set of data elements for each secondary applications 46, 48, 50, 52. The shared set of data elements may be those data elements that correspond to data elements of the available set of data elements for the central application 42. That is, the shared data elements are those which overlap with data elements of the central application 42. Each data element of the shared set of data elements is mapped to a data element of the available set of data elements. eMAC application 44 may automatically detect the mapping between the data elements of the secondary applications 46, 48, 50, 52 and the data elements of the central application 42, as they may have a corresponding identifier or reference indicating the link or may otherwise indicate the link. For example, the central application 42 may provide a list of available data elements and corresponding references so that when the secondary applications 46, 48, 50, 52 they may use the same references for the shared data elements. Further, eMAC application 44 may be manually configured with the mapping between the data elements of the secondary applications 46, 48, 50, 52 and the data elements of the central application 42 if a secondary application 46, 48, 50, 52 uses different references for the same data element than the central application 42. For example, eMAC application 44 may be programmed with a mapping for one or more secondary applications 46, 48, 50, 52 to link shared data elements from the secondary applications 46, 48, 50, 52 to the available data elements of the central application 42.

Upon determining that the central application 42 has initialized on the user device 16, the available set of data elements are transferred from the central application server 10 or data storage device 14a, 14b to the user device 16 for storage in the virtual memory of the user device 16. The eMAC application 44 or the central application 42 may initiate the transfer. The available set of data elements are stored in the virtual memory of the user device 16 for access by the central application 42 and the secondary applications 46, 48, 50, 52. Upon determining that a secondary application 46, 48, 50, 52 has initialized on the user device 16, eMAC application 44 is configured to populate the secondary application with data elements of the available set of data elements stored in the virtual memory that are mapped to data elements of the shared set of data elements of the secondary application 46, 48, 50, 52. A data element may include a data field and a data value pair, and the secondary application 46, 48, 50, 52 may include a data form with various data fields to receive input data. Some or all of the data fields may correspond to the shared data elements and those data fields may be populated with the data values of the corresponding data fields of the available set of data elements mapped to the shared data elements. In this way some or all of the data elements of the available set of data elements may be used by one or more secondary applications 46, 48, 50, 52 as well as the central application 42 to avoid redundant data entry and reduce data input errors. Further, this may reduce memory usage as multiple instances of the same data field/data value may be stored as one data element used by multiple applications 40. Some of the data fields may not correspond to the shared data elements and the corresponding data values may be received as data input via manual text entry by the user using input/output devices 28, imported from an external storage device 14b, or otherwise.

eMAC application 44 may be an independent application or may be embedded in the central application 42. eMAC application 44 may determine and collect the required information variables (e.g. data elements) from the secondary applications 46, 48, 50, 52 that need to be pulled from virtual memory, and, in particular, from the available set of data elements of the central application 42. The data elements may be retrieved from the central application server 10 when initialization of the central application 42 is detected and stored in virtual memory for distribution to secondary application 46, 48, 50, 52 upon initialization. eMAC application 44 may collect the required information from the central application 42 and central application server 10 and hold these data elements in virtual memory of the user device 16. When the secondary application 46, 48, 50, 52 is initialized or launched eMAC application 44 will insert the correct data values in the correct data fields within the secondary application 46, 48, 50, 52 based on the mapping between the shared set of data elements of the secondary application 46, 48, 50, 52 and the available set of data elements of the central application 42.

Each secondary application 46, 48, 50, 52 may have the data elements required from the central application flagged. When the secondary application 46, 48, 50, 52 is identified as a tool bar application, those flags may be sent to the eMAC application 44 to generate a mapping. eMac application 44 may also generate the mapping by detecting data elements of secondary application 46, 48, 50, 52 that correspond to data elements of the available set of data elements of the central application 42. Accordingly, eMAC application 44 may identify what data elements are required by which secondary application 46, 48, 50, 52 and determine whether they are correspond to data elements of the available set of data elements of the central application 42. The central application 42 or eMac application may distribute data elements from virtual memory to the correct data fields in the secondary application 46, 48, 50, 52 as the secondary application 46, 48, 50, 52 is initialized within the toolbar.

Accordingly, eMAC application 44 is configured to make data elements available for secondary applications 46, 48, 50, 52 through virtual memory of the user device 16. The data elements are identified in the secondary applications 46, 48, 50, 52 and sent to the eMAC application to generate a mapping to the set of available data elements of the central application 42. Data elements of the available set of data elements may be erased from virtual memory when the central application 42 closes.

A secondary application 46, 48, 50, 52 may require data elements that are not within the set of available data elements of the central application 42. Those data elements may be received as input to the user device 16 and stored in virtual memory. The data elements may also be stored in an external storage device 14b via cloud services 16 for subsequent access and retrieval. When the secondary application 46, 48, 50, 52 completes a transaction and closes then this may trigger transmission of the data elements to the external storage device 14b and the data elements may be erased from virtual memory. When the secondary application reinitiates or re-launches then the stored data elements that are not part of the set of available data elements may be retrieved from the external storage device 14b via cloud services 16 to populate the secondary application 46, 48, 50, 52.

By making the data elements variable depending on the secondary application 46, 48, 50, 52 that is initialized and by making multiple, modular, independent secondary applications 46, 48, 50, 52 to expand the functionality of the central application instead of having one large comprehensive application that performs all functions of the multiple secondary applications 46, 48, 50, 52 the amount of processing required by the user device 16 may be reduced. The user device 16 may run each secondary application 46, 48, 50, 52 separately depending on the functionality desired by the user. Also, the amount of memory required to run the secondary application 46, 48, 50, 52 may also be reduced as only the data elements and instructions specific to a given secondary application 46, 48, 50, 52 are used for a transaction. This may allow the user device 16 to run multiple secondary applications 46, 48, 50, 52 more independently and efficiently while still providing a variety of functionality to an end user.

In accordance with some embodiments, eMac application 44 may be configured to manage memory within the user device 16 thereby reducing memory leaks or processing inefficiencies by, for example, deleting data elements from virtual memory when a secondary application 46, 48, 50, 52 is shut down, while still retaining the set of available data elements for sharing with other secondary applications 46, 48, 50, 52. Typically, as more secondary applications 46, 48, 50, 52 are opened more memory is consumed. eMac application 44 is operable to monitor memory usage and ensure secondary applications 46, 48, 50, 52 are closed down as the user moves from a secondary application 46, 48, 50, 52 to another secondary application 46, 48, 50, 52. By ensuring proper close down of the secondary applications eMAC will continue to optimize memory resources.

User device 16 may also include various hardware components 20 such as, for example, a communication bus 22, central processing unit (CPU) 24, display 26, input/output device(s) 28, memory 30, network interface 32, and peripherals 34. User device 16 may include some or all of the hardware components 20, and different user devices 16 may have different hardware components 20.

Communication bus 22 is a subsystem that may transfer data between hardware components 20 inside user device 16, or between user devices 16. Communication bus 22 may refer to any physical arrangement that provides data communication functionality such as a parallel electrical bus, both parallel and bit serial connections, wired in various topologies, or connected by switched hubs, and so on.

CPU 24 may execute applications 54, computer readable instructions or programs stored in memory 30, or received from network 12. Memory 30 includes physical devices used to store applications (e.g. programs of instruction) or data on a temporary or permanent basis. For example, memory 30 may store one or more applications 54 for execution by CPU 24. Memory 30 may include primary storage devices for high-speed access as well as secondary and tertiary storage devices for slower access but higher memory capacity such as, for example, a hard disk drive, floppy disk drive, CD drive, DVD drive, Blu-ray drive, or other types of non-volatile data storage. Memory 30 may include volatile and non-volatile memory. Examples of non-volatile memory are flash memory (sometimes used as secondary, sometimes primary computer memory) and ROM/PROM/EPROM/EEPROM memory. Examples of volatile memory are primary memory (e.g. RAM, DRAM), and fast CPU cache memory (e.g. RAM, SRAM). User device 16 may comprise a management unit for memory 30 to implement virtual memory in order to virtualize the user device's 16 various forms of computer data storage (such as RAM and disk storage), allowing an application 54 to be designed as though there is only one kind of memory, namely, virtual memory, to hide fragmentation of physical memory 30 and create a direct and contiguous addressable read/write memory 30.

Input/output device(s) 28 may include any input device for entering information into user device 16, such as a keyboard, key pad, computer mouse, cursor-control device, touch-screen, camera, or microphone, for example, and any output device for presenting information, such as a printer, lights, or speakers, for example. An example output device may be a display device 26 which may include any type of device for presenting visual information such as, for example, a computer monitor, flat-screen display, projector or display panel. In some cases, user device 16 may include multiple communication buses 22, CPUs 24, displays 26, input/output devices 28, memory 30, network interfaces 32, and peripherals 342.

Network interface 32 may be wired or wireless network interfaces that allows user device 16 to connect to a communication network 12. Peripheral device(s) 42 may include auxiliary devices that connect to user device 16 but are not integrally part of it. In some examples, peripheral devices 42 may include display 26 (e.g. external display that is not integrally part of user device 16), input/output devices 28 such as computer mouse, printers, and scanners, and other examples such as a hard drive, expansion cards, graphics cards, tape drives, microphones, loudspeakers, webcams, digital cameras, and so on.

User device 16 may include an operating system 38 which may be a collection of software that manages software and hardware resources. For example, operating system 38 may be used for CPU 24 management, storage/memory 30 management, device management (including display 26, input/output device 28, and peripherals 34), and so on. Operating system 38 may also provide common services for applications 54 and mechanisms for applications 54 to interact with hardware components 20. Operating system 38 may also provide a user interface which creates structure to the interaction between the user and the user device 16. User device 16 may also include one or more application programming interfaces (API) 40 which may provide an interface for software and hardware components to communicate with each other. API 40 may include specifications for routines, data structures, object classes, variables, and so on. Applications 40 may interact with the operating system 38 via an API 40, and may interact with hardware components 20 via an API 40. User device 16 may also include one or more drivers 36, which may be computer programs that operate or control hardware components 20. A driver 36 typically communicates with a particular hardware component 20 through the communication bus 22 or communication subsystem to which the hardware component 20 connects. Driver 36 may be a translator between the electrical signals of the hardware components 20 and the programming languages of applications 40 and the operating system 38.

Referring now to FIG. 3 there is shown another schematic diagram of a user device 16 configured with an eMac application 44 according to some embodiments.

The user device 16 may be configured to provide a user interface with a toolbar or widget on which on-screen buttons, icons, menus, or other input or output elements may be placed. The icons may represent the central application 42, eMac application 44 and the secondary applications 46, 48, 50, 52. The icons may be activated using input/output devices 28 to initialize the central application 42 and the secondary applications 46, 48, 50, 52. The icons for the secondary applications 46, 48, 50, 52 may be configured to be organized in a tool bar or menu bar located at the bottom of the screen relative to the central application 42 and eMac application 44. This is a non-limiting example only and other configurations may be used for the central application 42, eMac application 44 and the secondary applications 46, 48, 50, 52. The eMAC application 44 identifies what application 40 will be the central application 42 in order to determine the available set of data elements. The central application 42 may be an application 40 the application that is a timeliest, suitable, accurate, and data rich application 40, as an example. The user may pick the secondary applications 46, 48, 50, 52 they require to run their day. The set of secondary applications 46, 48, 50, 52 may be modified and may vary between user devices 16. Further, the central application 42 may change and may vary between user devices 16. These secondary applications 46, 48, 50, 52 may be identified in a small menu bar within the central application 42. Once the secondary applications 46, 48, 50, 52 are identified then the eMac application 44 determines a set of shared data elements for each secondary application 46, 48, 50, 52. That is, for each secondary application 46, 48, 50, 52, eMac application 44 determines which data elements intersect with or are common to the available set of data elements from the central application 42. In accordance with some embodiments, eMac application 44 may automatically identify a central application 42 from a set of applications 40 that includes the most data elements on common with the other applications 40. eMac application 44 may automatically determine a mapping between the data elements of the available set of data elements for the central application 42 and data elements of the shared set of data elements for each for each secondary application 46, 48, 50, 52.

Secondary applications 46, 48, 50, 52 may identify what information (e.g. data elements) is required by the respective secondary applications 46, 48, 50, 52 and may further identify where the information is located in the script, program code, data form, and so on of the respective secondary application 46, 48, 50, 52. This is matched against what data elements are available from the central application 42 and to determine a shared set of data elements for the respective secondary application 46, 48, 50, 52, where each data element in the shared set of data elements is mapped to a data element of the available set of data elements. The mapping or link between each shared set of data elements and the available set of data elements may be automatically determined by the eMac application 44, manually programmed into the eMac application 44, and so on. For example, the central application 42 may have data elements a, b, c, d, e and f which for its available set of data elements. The data elements may have a data field and a corresponding data value. This available set of data elements is identified in eMac application 44, retrieved from central application server 10, for example, and then stored in virtual memory of the user device 16. This retrieval and storage may occur when the central application initializes. Further, central application 42 may receive corresponding data values for data elements of the available set of data elements as input at user device 16 in order to update the virtual memory 16 and provide the new data values to central application server 10. A secondary application A 46 may indicate to eMac application 44 that it uses data elements d, e and f and the data fields or locations in which these elements are used within secondary application 46, 48, 50, 52. As an illustrative example, the user may be a tow truck operator contracting with a vehicle services company. The central application 42 may be a dispatch application on user device 16 that the user regularly runs in order to be dispatched to service requests. Example data element fields for the available set of data elements from the central application 42 may be: membership number, membership type, club association; member name; member address; car make and car model.

eMac application 44 may be further configured to identify any information (e.g. data elements) created in the secondary application 46, 48, 50, 52 that could be required by the central application 42. Upon detecting creation of new data elements by secondary application 46, 48, 50, 52, eMac application 44 is operable to provide the new data elements to central application, central application server 10, data storage devices 14a, 14b, and so on. Accordingly, newly created data elements from secondary application 46, 48, 50, 52 may be provided to central application 10 and, in turn, become part of the available set of data elements for provision to additional secondary applications 46, 48, 50, 52. Further, a secondary application 46, 48, 50, 52 may receive updates or modifications to data values for data elements initially populated into the secondary application 46, 48, 50, 52 as part of the shared set of data elements. The updates or modifications may in turn update the corresponding data element of the available set of data elements stored in virtual memory or may become a new data element stored in virtual memory in association with the secondary application 46, 48, 50, 52.

The user device 16 is configured to launch the central application 42. If during their day the user requires the use of a secondary application 46, 48, 50, 52 they may activate a corresponding icon on the menu bar or otherwise initialize the secondary application 46, 48, 50, 52. As the secondary application 46, 48, 50, 52 opens eMAC application 42 identifies the data elements that the secondary application 46, 48, 50, 52 requires which includes data elements that are part of its shared set of data elements. eMAC application 42 will request the shared set of data elements from virtual memory of the user device 16. As noted, when the central application 42 launches the available set of data elements may be retrieved from central application server 10 and stored in the virtual memory of user device 16. As an example, the secondary application 46, 48, 50, 52 may provide a data form to receive data values as input for corresponding data fields. As the secondary application 46, 48, 50, 52 opens up then the data elements from the available set of data elements from the central application 42 and stored in virtual memory are inserted into the proper fields in the secondary application 46, 48, 50, 52. This may reduce redundant data entry, and errors between applications 40 as the data elements are shared between the applications 40. Any secondary application 46, 48, 50, 52 that requires information beyond what is provided from the central application may receive the additional information as input via user device 16 or otherwise.

Once the user is finished in the secondary application 46, 48, 50, 52 they can move to another secondary application 46, 48, 50, 52 or back to the central application 42. If the central application 42 requires any information (e.g. data elements) from what has been manually input into the secondary application 46, 48, 50, 52, eMAC application 44 is configured to pass that information back to the central application 42 via virtual memory for storage at central application server 10 and redistribution. This may expand the number of data elements available from the central application 42 and provide a mechanism to share data elements between secondary applications 46, 48, 50, 52.

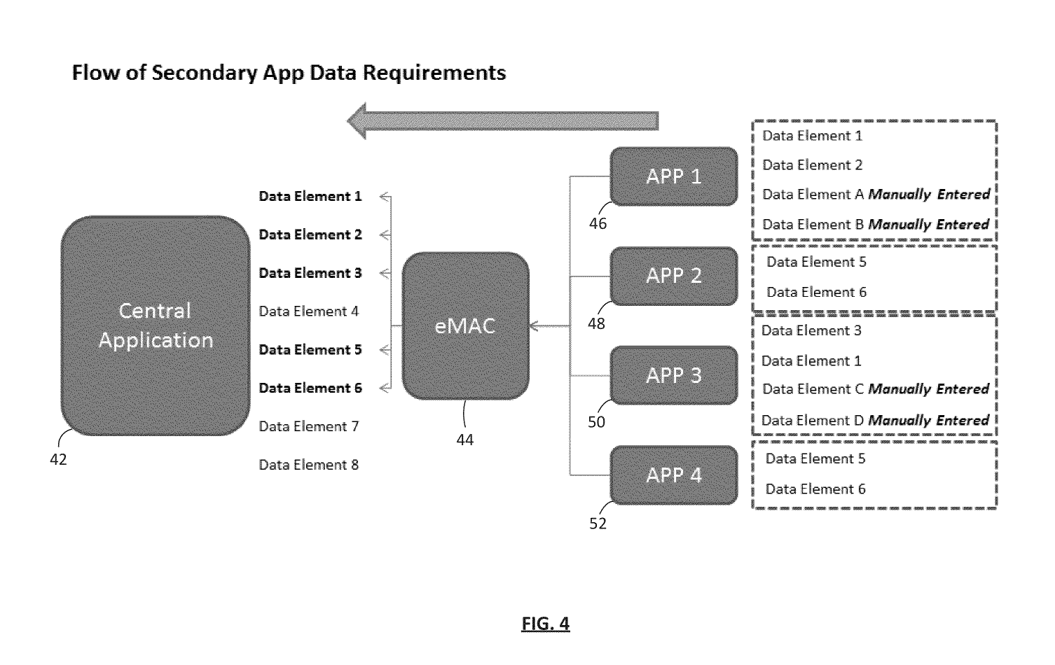

Referring now to FIG. 4, there is shown a schematic diagram illustrating data flow from secondary applications 46, 48, 50, 52 to eMac application 44 and a central application 42 according to some embodiments. For this example, central application 42 has an available set of data elements which includes: data element 1, data element 2, data element 3, data element 4, data element, 5, data element 6, data element 7, and data element 8. Secondary application 1 46 involves data element 1, data element 2, data element A, and data element B. For secondary application 1 46, eMac application 44 identifies data element 1 and data element 2 as the shared set of data elements for the respective secondary application 1 46 and configures a mapping to the set of data elements available from central application 42. For secondary application 1 46, data element A, and data element B are not available from central application 42 and may need to be received as input from user device 16 or otherwise. Secondary application 2 48 involves data element 5 and data element 6. For secondary application 2 48, eMac application 44 identifies both data element 5 and data element 6 as the shared set of data elements for the respective secondary application 2 48 and configures a mapping to the set of data elements available from central application 42. Secondary application 3 50 involves data element 3, data element 1, data element C, and data element D. For secondary application 3 50, eMac application 44 identifies data element 1 and data element 3 as the shared set of data elements for the respective secondary application 3 50 and configures a mapping to the set of data elements available from central application 42. For secondary application 3 50, data element C, and data element D are not available from central application 42 and may need to be received as input from user device 16 or otherwise. Secondary 4 52 involves data element 5 and data element 6. For secondary application 4 52, eMac application 44 identifies both data element 5 and data element 6 as the shared set of data elements for the respective secondary application 4 52 and configures a mapping to the set of data elements available from central application 42.

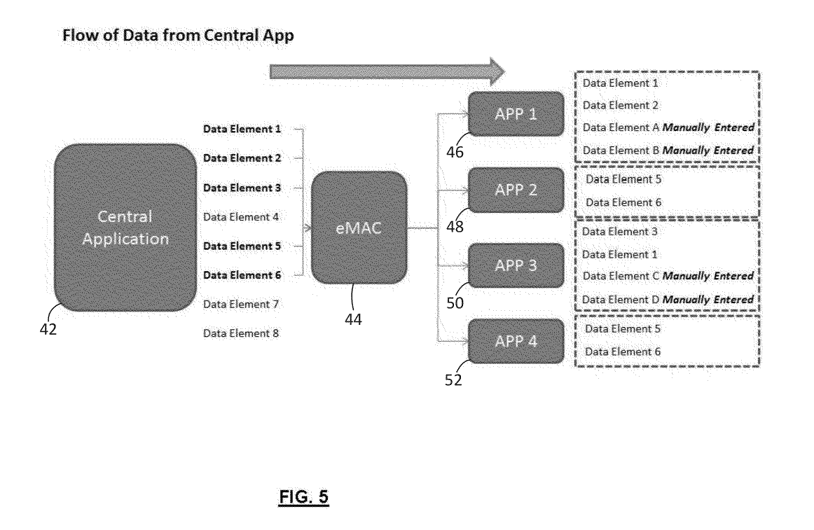

Referring now to FIG. 5, there is shown a schematic diagram illustrating data flow from a central application 42 to an eMac application 44 and to secondary applications 46, 48, 50, 52 according to some embodiments. Central application 42 is operable to make the following data elements available to this set of secondary applications 46, 48, 50, 52: data element 1, data element 2, data element 3, data element 5, and data element 6. Central application 42 may make data element 4, data element 7 and data element 8 available for a different set of secondary applications 46, 48, 50, 52, as required. Upon receipt of data element 1, data element 2, data element 3, data element 5, and data element 6, eMac application 44 is configured to store the data elements in virtual memory for access by secondary applications 46, 48, 50, 52.

As a non-limiting illustrative example, user device 16 may be used by tow truck operators. A tow truck operator may configure user device 16 with selected secondary applications 46, 48, 50, 52 required for their day. For this example, three secondary applications 46, 48, 50, 52 may be: cash on delivery application, damage inspection application, and vehicle drop off Application. The tow truck operator begins their day and carries user device 16. The central application 42 may be a dispatch application so that the tow truck operator can receive service requests from a dispatch operator, for example. The tow truck operator may use the central application 42 throughout the day and it may be continually running on user device 16. The tow truck operator may receive calls from dispatch operator for requested vehicle services and completes call. The tow truck operator may open a secondary application 46, 48, 50, 52 in tool bar, such as for example the damage inspection application, which may enable a tow truck operator to record details regarding damage to a vehicle prior to providing a tow as evidence that the tow operator is not responsible for damage detected. The damage detection application may receive one or more photos of the damage along with information regarding the damaged vehicle. Launch of secondary applications 46, 48, 50, 52 may engage eMAC application 44 which determines that the damage inspection application can use the following information from the central application 42: membership number; GPS coordinates; car make; car model; car year; customer name; and customer address (e.g. the shared set of data elements mapped to the available set of data elements from central application 42). The data elements are pulled upon initialization of the central application 42 from central application server 10 and stored in virtual memory of the user device 16. As a secondary application 46, 48, 50, 52 launches eMAC application 44 inserts the data elements of the shared set of data elements for the respective secondary application 46, 48, 50, 52 into the secondary applications 46, 48, 50, 52, and in particular, the inserts the data values into the correct data fields. The operator provides as input the rest of the information not provided by the eMAC application 44 for the damage inspection application, such as a photo of the damage. Once the transaction is completed, the operator hits complete to close the eMAC application 44 and is taken back to the central application 42. Information from the secondary application 46, 48, 50, 52 is stored and/or forwarded to the central application 42 and central application server 10 for storage and redistribution, or to another cloud based data storage device 14b for storage and retrieval. The operator continues his/her day and launches additional secondary applications 46, 48, 50, 52 as needed. The data elements stored in virtual memory that are specific to a secondary application 46, 48, 50, 52 and that are not part of the available set of data elements may be deleted once the secondary application 46, 48, 50, 52 is closed for efficient memory management. As noted, those deleted data elements may be stored as a data record by cloud services 6 and data storage device 14b for subsequent retrieval.

Embodiments described herein may target mobile applications 40 that can multi-thread. Embodiments described herein may also allow for a variable integration dictated by the secondary application 46, 48, 50, 52 along with configuration from user input.

Embodiments described herein may reduce the need for companies to build big one shot comprehensive applications that contain functionality for various work groups. Instead, eMac application 42 enables a modular approach by providing functionality in various secondary applications 46, 48, 50, 52 that process independent. Instead of launching on big shot application that includes all functionality to perform a single directed task, such as damage inspection, user device 16 need only launch a smaller specialized secondary applications 46, 48, 50, 52. The eMAC application 42 may allow companies to build small applications that tie into a central application. A more modular approach to software design may reduce testing cycles, improve quality and reduce process burden on the mobile device.

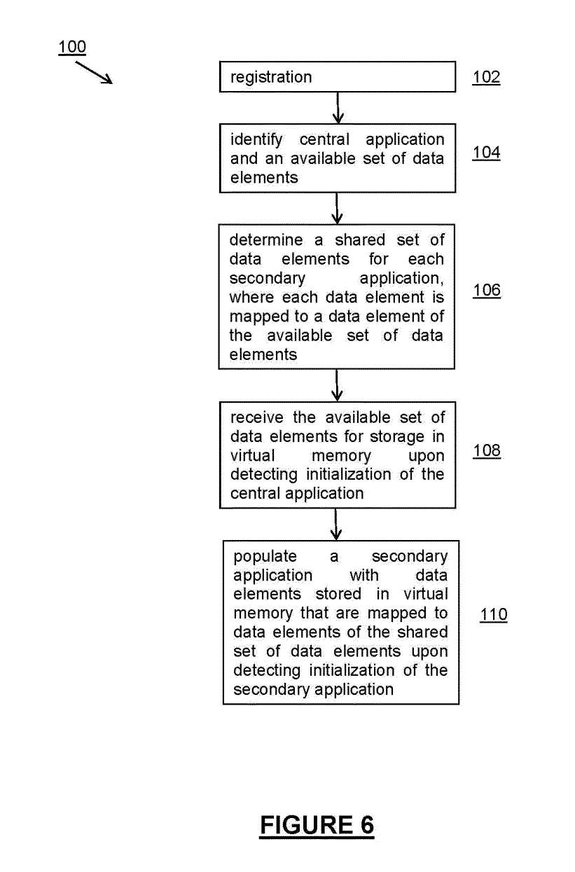

Referring now to FIG. 6 there is shown a flow chart of a method 100 for managing data elements on a mobile device according to some embodiments. The method 100 may be implemented on a mobile device, such as user device 16.

At 102, a central application 42 residing in the memory of the mobile device 16 is identified, along with an available set of data elements for the central application 42. The central application 42 is in communication with an external central application server 10 and data storage device 14a storing the available set of data elements. In accordance with some embodiments, each data element comprises a data field and a corresponding data value, where the data field indicates the location within the application 40 to be populated with the data value.

At 104, eMac application 44 detects a set of secondary applications 46, 48, 50, 52 residing in memory of the mobile device 16, which may, for example, be a set of secondary applications 46, 48, 50, 52 pinned to a toolbar or menu bar of the mobile device 16. For each secondary application 46, 48, 50, 52, eMac application 44 determines a shared set of data elements, and along with a mapping or link between each data element of the shared set of data elements to a data element of the available set of data elements.

A secondary application 46, 48, 50, 52 may have a base set of data elements, where the shared set of data elements for the secondary application 46, 48, 50, 52 is a subset of the base set of data elements. The base set of data elements may also include one or more data element that are not part of the shared set of data elements.

At 106, upon determining that a central application 42 has initialized on the mobile device 16 central application server 10 provides the available set of data elements to the mobile device 16 for storage in a virtual memory of the mobile device 16. The data elements are populated into the central application 42 from virtual memory, and in particular the data values are populated into the correct data fields of central application 42. The data values may be modified or updated which may in turn modify the virtual memory. The updates and modifications may be propagated back to central application server 10 for storage and distribution.

At 108, upon determining that a secondary application 46, 48, 50, 52 has initialized on the mobile device 16, the eMac application 44 is operable to retrieve data elements from virtual memory to populate the secondary applications 46, 48, 50, 52 with data elements of the available set of data elements stored in the virtual memory that are mapped to the shared set of data elements of the respective secondary application 46, 48, 50, 52. The eMac application 44 is operable to populate the data values into the correct corresponding data fields. The mobile device 16 may also receive as input data values for the data elements that are not part of the shared set of data elements. eMac application 44 may determine that data elements that are not part of the shared set of data elements are required by the central application, and store those data elements in virtual memory for provision to the central application 42. Further, eMac application 42 may then update the available set of data elements for the central application to include the data elements that were not initially part of the shared set of data elements, for provision to other secondary applications 46, 48, 50, 52 or otherwise. Upon updating the available set of data elements, eMac application 44 may be configured to, for of the other secondary applications 46, 48, 50, 52 re-determine a shared set of data elements, where each data element of the shared set of data elements is mapped to a data element of the updated available set of data elements. The new data elements may be transmitted to central application server 10 or cloud services 6 for storage on data storage devices 14a, 14b. The new data elements may also be stored in virtual memory.

In accordance with some embodiments, the central application 42 may be in real time communication with central application server 10 to receive real time updates to the available set of data elements stored in the virtual memory of the mobile device 16.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

1. A method for managing data elements on a mobile device, wherein the mobile device comprises a processor and a memory coupled to the processor and configured to store instructions executable by the processor to perform the method comprising:
a) identifying a central application residing in the memory of the mobile device, wherein the central application has an available set of data elements, wherein the central application is in communication with an external data storage device storing the available set of data elements;
b) for each of a plurality of secondary applications residing in memory of the mobile device, determining a shared set of data elements using the processor, wherein each data element of the shared set of data elements is mapped to a data element of the available set of data elements;
c) upon determining that a central application has initialized on the mobile device, receiving the available set of data elements from the external data storage device for storage in a virtual memory of the mobile device; and
d) upon determining that a secondary application of the plurality of secondary applications has initialized on the mobile device, populating the secondary application with data elements of the available set of data elements stored in the virtual memory that are mapped to data elements of the shared set of data elements of the secondary application.

2. The method of claim 1, wherein the plurality of secondary applications are located within a menu bar of a user interface for the mobile device.

3. The method of claim 1, wherein each data element comprises a data field and a corresponding data value, wherein the data field indicates the location within the secondary application to be populated with the data value.

4. The method of claim 1, wherein a secondary application of the plurality of secondary applications has a base set of data elements, wherein the shared set of data elements for the secondary application is a subset of the base set of data elements, wherein the base set of data elements comprises at least one data element that is not part of the shared set of data elements, and wherein the method further comprises: receiving a data value for the at least one data element that is not part of the shared set of data elements.

5. The method of claim 4, further comprising upon determining that the at least one data element that is not part of the shared set of data elements is required by the central application, providing the data value for the at least one data element that is not part of the shared set of data elements to the central application.

6. The method of claim 5, further comprising updating the available set of data elements for the central application to comprise the at least one data element that is not part of the shared set of data elements.

7. The method of claim 6, further comprising, for each of a plurality of secondary applications residing in memory of the mobile device, re-determining a shared set of data elements, wherein each data element of the shared set of data elements is mapped to a data element of the updated available set of data elements.

8. The method of claim 4, transmitting the data value for storage on the external storage device.

9. The method of claim 4, further comprising storing the data value in the virtual memory of the mobile device.

10. The method of claim 1, wherein the central application is in communication with an external data storage device storing the available set of data elements to receive real time updates to the available set of data elements stored in the virtual memory of the mobile device.

11. A system for managing data elements on a mobile device, wherein the mobile device comprises a processor and a memory coupled to the processor and configured to store instructions executable by the processor to:
a) identify a central application residing in the memory of the mobile device, wherein the central application has an available set of data elements, wherein the central application is in communication with an external data storage device storing the available set of data elements;
b) for each of a plurality of secondary applications residing in memory of the mobile device, determine a shared set of data elements, wherein each data element of the shared set of data elements is mapped to a data element of the available set of data elements;
c) upon determining that a central application has initialized on the mobile device, receive the available set of data elements from the external data storage device for storage in a virtual memory of the mobile device; and
d) upon determining that a secondary application of the plurality of secondary applications has initialized on the mobile device, populate the secondary application with data elements of the available set of data elements stored in the virtual memory that are mapped to data elements of the shared set of data elements of the secondary application.

12. The system of claim 11, wherein the plurality of secondary applications are located within a menu bar of a user interface for the mobile device.

13. The system of claim 11, wherein each data element comprises a data field and a corresponding data value, wherein the data field indicates the location within the secondary application to be populated with the data value.

14. The system of claim 11, wherein a secondary application of the plurality of secondary applications has a base set of data elements, wherein the shared set of data elements for the secondary application is a subset of the base set of data elements, wherein the base set of data elements comprises at least one data element that is not part of the shared set of data elements, and wherein the method further comprises: receiving a data value for the at least one data element that is not part of the shared set of data elements.

15. The system of claim 14, wherein the processor is further configured to, upon determining that the at least one data element that is not part of the shared set of data elements is required by the central application, provide the data value for the at least one data element that is not part of the shared set of data elements to the central application.

16. The system of claim 15, wherein the processor is further configured to update the available set of data elements for the central application to comprise the at least one data element that is not part of the shared set of data elements.

17. The system of claim 16, wherein the processor is further configured to, for each of a plurality of secondary applications residing in memory of the mobile device, re-determining a shared set of data elements, wherein each data element of the shared set of data elements is mapped to a data element of the updated available set of data elements.

18. The system of claim 14, wherein the processor is further configured to transmit the data value for storage on the external storage device.

19. The system of claim 14, wherein the processor is further configured to store the data value in the virtual memory of the mobile device.

20. The system of claim 11, wherein the processor is further configured to, wherein the central application is in communication with an external data storage device storing the available set of data elements to receive real time updates to the available set of data elements stored in the virtual memory of the mobile device.
